(19) United States
(12) Patent Application Publication
(10) Pub. No.: US 2025/0273776 A1
(43) Pub. Date: Aug. 28, 2025

(54) POUCH FOR ALL-SOLID-STATE BATTERY WITH ENHANCED STABILITY AND POUCH CELL INCLUDING SAME

(71) Applicants: Hyundai Motor Company, Seoul (KR); Kia Corporation, Seoul (KR)

(72) Inventors: Young Jin Nam, Seoul (KR); Yong Guk Gwon, Seoul (KR); Yeo Min Yoon, Seoul (KR); Yong Seok Choi, Seoul (KR); Min Sun Kim, Seoul (KR)

(21) Appl. No.: 18/923,429

(22) Filed: Oct. 22, 2024

(30) Foreign Application Priority Data
Feb. 28, 2024 (KR) 10-2024-0028458

(51) Int. Cl. H01M 50/122; H01M 50/105; H01M 50/119; H01M 50/121; H01M 50/124

(52) U.S. Cl. CPC H01M 50/122; H01M 50/105; H01M 50/119; H01M 50/121; H01M 50/1245

(57) ABSTRACT

A pouch for an all-solid-state battery with enhanced stability and a pouch cell including the same, in which the pouch for an all-solid-state battery and a battery assembly can be attached to each other using a nonwoven fabric impregnated with a water-curable adhesive. This configuration prevents internal short circuits in the pouch cell and minimizes the generation of flammable gas, thereby significantly improving safety characteristics.

### CROSS-REFERENCE TO RELATED APPLICATION

This application claims, under 35 U.S.C. § 119 (a), the benefit of Korean Patent Application No. 10-2024-0028458, filed on Feb. 28, 2024, the entire contents of which are incorporated herein by reference.

### BACKGROUND

### Technical Field

The present disclosure relates to a pouch for an all-solid-state battery with enhanced stability and a pouch cell including the same. The pouch and the battery assembly may be attached using a nonwoven fabric impregnated with a water-curable adhesive. This configuration helps prevent internal short circuits within the pouch cell and minimizes the generation of flammable gas, thereby significantly improving the safety characteristics of the battery.

### Background Art

In recent efforts to address environmental problems caused by carbon dioxide (CO₂) emissions, the use of fossil fuels has been reduced, leading the automotive industry to focus on electric vehicles powered by secondary batteries. Current lithium-ion batteries enable electric vehicles to travel approximately 400 km on a single charge, but they still pose issues such as instability at high temperatures and the risk of fire. To overcome these challenges, many
companies are actively developing next-generation secondary batteries.

All-solid-state batteries, which are receiving attention as next-generation secondary batteries, consist entirely of solid components. This design significantly reduces the risk of fire and explosion and offers higher mechanical strength than lithium-ion batteries, which utilize flammable organic solvents as electrolytes. The all-solid-state battery generally includes a cathode active material layer attached to a cathode current collector, an anode active material layer attached to an anode current collector, and a solid electrolyte layer disposed between the cathode active material layer and the anode active material layer. These components are generally stacked and sealed within a pouch, forming a pouch-type all-solid-state battery.

A conventional pouch for an all-solid-state battery may include a metal layer configured to seal the battery assembly and a silicone-based adhesive applied inside the metal layer to provide adhesion between the battery assembly and the metal layer. As such, the silicone-based adhesive may melt when exposed to a high temperature of about 150° C., causing internal short circuit of the battery assembly. Moreover, in the event of an external impact, such as the penetration of foreign substances into the pouch-type all-solid-state battery, a widely used sulfide-based solid electrolyte can be exposed to oxygen or water, potentially generating hydrogen sulfide (H₂S), a flammable gas.

### SUMMARY OF THE DISCLOSURE

The present disclosure has been made keeping in mind the problems encountered in the related art and is intended to provide a pouch for an all-solid-state battery capable of preventing internal short circuit even when an adhesive inside the pouch melts due to exposure to high temperatures.

In addition, the present disclosure is intended to provide a pouch for an all-solid-state battery, in which, when external impact such as penetration of foreign substances occurs and a solid electrolyte is exposed to oxygen and water introduced from the outside, a film is immediately formed on the surface of the electrolyte, thereby suppressing chain reaction due to water and generation of flammable gas.

The objects of the present disclosure are not limited to the foregoing. The objects of the present disclosure will be able to be clearly understood through the following description and to be realized by the means described in the claims and combinations thereof.

For some embodiments, a pouch for an all-solid-state battery includes a metal layer configured to surround a battery assembly and an inner adhesive layer configured to provide adhesion between the metal layer and the battery assembly. The inner adhesive layer comprises a nonwoven fabric impregnated with a water-curable adhesive.

The metal layer may comprise aluminum or an aluminum alloy. The nonwoven fabric may be selected from among glass fiber, silica, or a combination thereof. Additionally, the nonwoven fabric may have a coating layer on its surface, which may include ceramic, silicone, or a combination thereof. The porosity of the nonwoven fabric may range from about 10% to 70%, and its thickness may be about 10 μm to 300 μm. The inner adhesive layer may contain about 5 to 70 wt % of the water-curable adhesive.

The water-curable adhesive may be selected from the group consisting of an epoxy resin adhesive, a urethane resin adhesive, a modified silicone resin adhesive, a silicone resin adhesive, a cyanoacrylate resin adhesive, or combinations thereof. Specifically, the epoxy resin adhesive may include diglycidyl ether of bisphenol. The urethane resin adhesive may contain a soft segment with polyester diol and a hard segment with an isocyanate group (—N═C═O). The cyanoacrylate resin adhesive may comprise R-cyanoacrylate, where R may be hydrogen, linear or branched C₁-C₁₀ alkyl, allyl, or combinations thereof. The water-curable adhesive may also include up to about 25 wt % of an additive.

The additive may be an amine catalyst, a liquid catalyst, a particulate metal catalyst, or combinations thereof. The amine catalyst may be a tertiary amine, the liquid catalyst may be polyester polyol, and the metal catalyst may include tin (Sn), bismuth (Bi), lead (Pb), or combinations thereof.

For some embodiments, a pouch-type all-solid-state battery includes a battery assembly configured with an anode current collector, an anode active material layer, a solid electrolyte layer, a cathode active material layer, and a cathode current collector sequentially stacked. This assembly is sealed within the pouch described above.

For some embodiments, a pouch for an all-solid-state battery includes a metal layer configured to surround a battery assembly, an inner adhesive layer comprising a nonwoven fabric impregnated with a water-curable adhesive, and an outer protective resin layer formed on the outer lateral surface of the metal layer. The resin layer may include a polyester resin, which may be selected from polyethylene terephthalate (PET), polybutylene terephthalate (PBT), or polyethylene naphthalate (PEN). The metal layer may comprise aluminum or an aluminum alloy. As discussed, the method and system suitably include use of a controller or processer.

In some embodiments, vehicles are provided that comprise an apparatus as disclosed herein.

### BRIEF DESCRIPTION OF THE DRAWINGS

The above and other features of the present disclosure will now be described in detail referring to certain example embodiments thereof illustrated in the accompanying drawings, which are given hereinbelow by way of illustration only, and thus are not limitative of the present disclosure, and wherein:

FIG. 1 schematically shows a pouch for an all-solid-state battery according to the present disclosure;

FIG. 2 shows results of evaluation of thermal stability of an all-solid-state battery including the pouch according to the present disclosure;

FIG. 3 shows results of evaluation of thermal stability of an all-solid-state battery including a conventional pouch;

FIG. 4 shows results of a penetration test on the all-solid-state battery including the pouch according to the present disclosure; and

FIG. 5 shows results of a penetration test on the all-solid-state battery including the conventional pouch.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like. It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof. Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below. Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN). Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Pouch for all-solid-state battery According to an aspect of the present disclosure, a pouch for an all-solid-state battery serves to minimize generation of flammable gas (e.g., hydrogen sulfide gas) by chain reaction when external impact such as penetration of foreign substances occurs and a solid electrolyte in a battery assembly is exposed to oxygen and water introduced from the outside, and also to prevent internal short circuit from occurring even when the pouch is exposed to heat and the adhesive therein melts. Below, the pouch for the all-solid-state battery is described in more detail.

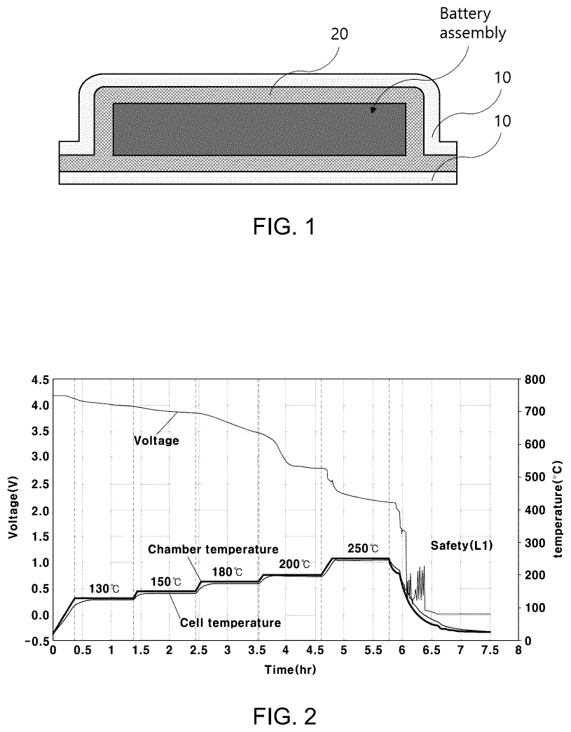

FIG. 1 schematically shows a pouch for an all-solid-state battery according to the present disclosure. The pouch for an all-solid-state battery according to FIG. 1 may include a metal layer 10 configured to surround the battery assembly and an inner adhesive layer 20.

The metal layer 10 may function to prevent inflow of foreign substances such as gas, water, etc., or leakage of internal components such as an adhesive, an electrolyte, etc. A material for the metal layer 10 is not particularly limited so long as it is able to perform the above functions, but may include aluminum (Al) or an aluminum alloy with excellent strength and formability. Examples of the aluminum alloy may include 8079, 1N30, 8021, 3003, 3004, 3005, 3104, 3105, and the like, which may be used alone or in combination of two or more.

The inner adhesive layer 20 is a layer for providing adhesion between the battery assembly and the pouch. The inner adhesive layer 20 may include a nonwoven fabric and a water-curable adhesive with which the nonwoven fabric is impregnated.

The nonwoven fabric may be a fabric made by mechanically treating fibers using heat and resin to entangle the same, and may include a space to be impregnated with an adhesive therein.

The fibers constituting the nonwoven fabric may have excellent heat resistance and electrical insulating properties, and may include, for example, any one selected from among glass fiber, silica, and combinations thereof.

In an embodiment, the nonwoven fabric may have pores formed therein such that the inside thereof is impregnated with an adhesive, and may have a porosity of, for example, 10% to 70%. If the porosity of the nonwoven fabric is less than 10%, there is not enough space to be impregnated with the adhesive, whereas if the porosity exceeds 70%, mechanical strength may decrease and excessive impregnation with a liquid or gel adhesive may occur.

In an embodiment, the nonwoven fabric may be subjected to surface treatment to improve durability of a fabric. Accordingly, the nonwoven fabric may include a coating layer formed on the surface thereof. Here, the surface of the nonwoven fabric may be understood as the surface of fibers that make up the nonwoven fabric. The coating layer is not particularly limited, so long as it is able to improve durability of the nonwoven fabric, and may include, for example, any one selected from the group consisting of ceramic, silicone, and combinations thereof.

In an embodiment, the thickness of the nonwoven fabric may be 10 μm to 300 μm. If the thickness of the nonwoven fabric is less than 10 μm, it may be difficult to provide enough space to be impregnated with the adhesive and also to exhibit high heat resistance and insulating properties of the nonwoven fabric. On the other hand, if the thickness of the nonwoven fabric exceeds 300 μm, flexibility of the pouch may be reduced due to excessive impregnation with the adhesive or increased mechanical strength.

According to the present disclosure, the inner adhesive layer 20 of the pouch for an all-solid-state battery includes a nonwoven fabric having high heat resistance and electrical insulating properties, and thus, even when the pouch is exposed to high temperatures and the adhesive incorporated in the nonwoven fabric melts, it is possible to prevent internal short circuit from occurring in the battery assembly.

The nonwoven fabric may be impregnated with a water-curable adhesive. The water-curable adhesive may be provided in liquid or gel form and may be an adhesive that absorbs water in the air and begins to cure due to water.

In an embodiment, the water-curable adhesive may include any one selected from the group consisting of an epoxy resin adhesive, a urethane resin adhesive, a modified silicone resin adhesive, a silicone resin adhesive, a cyanoacrylate resin adhesive, and combinations thereof.

For example, the epoxy resin adhesive may include diglycidyl ether of bisphenol.

The urethane resin adhesive may include a soft segment containing polyester diol and a hard segment containing an isocyanate group (—N═C═O).

The cyanoacrylate resin adhesive may include R-cyanoacrylate, in which R may include any one selected from the group consisting of hydrogen, linear or branched C₁-C₁₀ alkyl, allyl, and combinations thereof. Examples of the cyanoacrylate resin adhesive May include methyl cyanoacrylate, ethyl-2-cyanoacrylate, propyl cyanoacrylate, butyl cyanoacrylate, octyl cyanoacrylate, β-methoxyethyl cyanoacrylate, allyl cyanoacrylate, and the like.

In addition thereto, any adhesive that begins to cure when exposed to water may be used without particular limitation.

In an embodiment, the inner adhesive layer 20 may include 5 to 70 wt % of the water-curable adhesive. If the amount of the water-curable adhesive is less than 5 wt %, curing properties may deteriorate when water or oxygen is introduced from the outside, lowering the effects such as prevention of internal short circuit or suppression of generation of flammable gas such as hydrogen sulfide gas. On the other hand, if the amount of the water-curable adhesive exceeds 70 wt %, the nonwoven fabric may be excessively impregnated with a liquid or gel adhesive, deteriorating battery performance.

In an embodiment, the water-curable adhesive may further include an additive. The additive may be used to prevent the curing speed of the water-curable adhesive from decreasing when a phenomenon such as pouch penetration by external foreign substances occurs, and may be added to maintain or improve the curing speed of the water-curable additive. Accordingly, chain reaction such as flammable gas generation due to water exposure may be more effectively suppressed.

The additive may be used without particular limitation, so long as it is able to improve the curing speed of the water-curable adhesive. For example, any one selected from the group consisting of an amine catalyst, a liquid catalyst, a particulate metal catalyst, and combinations thereof may be included.

The amine catalyst may include a tertiary amine. Also, the liquid catalyst may include polyester polyol. Also, the metal catalyst may include any one selected from the group consisting of tin (Sn), bismuth (Bi), lead (Pb), and combinations thereof.

In an embodiment, the inner adhesive layer 20 may include 25 wt % or less of the additive. If the amount of the additive exceeds 25 wt %, the relative amounts of the nonwoven fabric and the water-curing additive in the inner adhesive layer 20 may decrease, lowering the effects such as prevention of internal short circuit due to curing of the adhesive, suppression of chain reaction, etc.

Although not separately shown, the outer lateral surface of the metal layer 10 may further include a resin layer that serves to protect the battery cell from the outside. The resin layer requires excellent tensile strength and weather resistance relative to the thickness thereof, and for example, polyester resins, such as polyethylene terephthalate (PET), polybutylene terephthalate (PBT), polyethylene naphthalate (PEN), etc. polyolefin resins, such as polyethylene (PE), polypropylene (PP), etc., polystyrene resins, such as polystyrene, etc., polyvinyl chloride resins, polyvinylidene chloride resins, and the like may be used. These materials may be used alone or in combination of two or more, and ONy (stretched nylon film) may be used.

Pouch-Type all-Solid-State Battery

Another aspect of the present disclosure pertains to a pouch-type all-solid-state battery, including a battery assembly configured such that an anode current collector, an anode active material layer, a solid electrolyte layer, a cathode active material layer, and a cathode current collector are sequentially stacked, and the pouch described above configured to seal the battery assembly.

Sealing the battery assembly in the pouch may be performed by a method commonly used in the art. For example, as shown in FIG. 1, two pouch sheets for an all-solid-state battery may be prepared, after which a battery assembly is disposed therebetween and then hot pressed, thereby sealing the battery assembly in the pouch. Although not separately shown, electrode tabs that transmit the current of the battery assembly to the outside may be disposed in the form of penetrating the region sealed by the pouch.

The anode current collector may be a plate-type substrate having electrical conductivity. Specifically, the anode current collector may be in the form of a sheet, a thin film, or a foil. The anode current collector may include a material that does not react with lithium. Specifically, the anode current collector may include any one selected from the group consisting of Ni, Cu, SUS (stainless steel), and combinations thereof.

The thickness of the anode current collector is not particularly limited and may be, for example, 1 μm to 500 μm.

The anode active material layer may include an anode active material and a binder. Additionally, some of the solid electrolyte may be mixed. The anode active material may include a carbon-based anode active material, a non-carbon-based anode active material, etc.

The carbon-based anode active material may include graphite such as mesocarbon microbeads (MCMB), highly oriented pyrolytic graphite (HOPG), etc., and amorphous carbon such as hard carbon and soft carbon. The non-carbon-based anode active material may include a metal, metal oxide, etc. containing at least one selected from the group consisting of In, Al, Si, Sn, and combinations thereof.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The solid electrolyte layer may be disposed between the cathode active material layer and the anode active material layer and may include a solid electrolyte having lithium ion conductivity.

The solid electrolyte may include at least one selected from the group consisting of an oxide-based solid electrolyte, a sulfide-based solid electrolyte, a polymer electrolyte, and combinations thereof. However, it is preferable to use a sulfide-based solid electrolyte having high lithium ion conductivity.

The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers, and M is any one selected from among P, Si, Ge, B, Al, Ga, and In), Li₁₀GeP₂S₁₂, and the like. Preferably, a sulfide-based solid electrolyte having an argyrodite crystal structure is used.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like. Examples of the polymer electrolyte may include a gel polymer electrolyte, a solid polymer electrolyte, and the like.

The solid electrolyte layer may further include a binder. Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode active material layer is configured to reversibly store and release lithium ions, and may include a cathode active material, a conductive material, and a binder. Additionally, some of the solid electrolyte may be mixed. Here, the solid electrolyte that may be included or mixed in the cathode active material layer and the anode active material layer may be the same as or different from that included in the solid electrolyte layer.

The cathode active material may be an oxide active material or a sulfide active material.

Examples of the oxide active material may include a rocksalt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-including active material such as Li₂FeSiO₄, Li₂MnSiO₄, etc., a rocksalt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (in which M is at least one selected from among Al, Mg, Co, Fe, Ni, and Zn, 0<x+y<2), lithium titanate such as Li₄Ti₅O₁₂, and the like.

Examples of the sulfide active material may include copper Chevrel, iron sulfide, cobalt sulfide, nickel sulfide, and the like.

Examples of the conductive material may include carbon black, conductive graphite, ethylene black, carbon fiber, graphene, and the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode current collector may be a plate-type substrate having electrical conductivity. Specifically, the cathode current collector may be in the form of a sheet or a thin film. The cathode current collector may include at least one selected from the group consisting of indium (In), copper (Cu), magnesium (Mg), aluminum (Al), stainless steel, iron, and combinations thereof. Specifically, the cathode current collector may include an aluminum foil.

The thickness of the cathode current collector is not particularly limited and may be, for example, 1 μm to 500 μm.

Although a battery assembly is shown as being disposed inside the pouch in FIG. 1, but of course, a stack of battery assemblies may also be used.

A better understanding of the present disclosure may be obtained through the following examples and comparative examples. However, these examples are not to be construed as limiting the technical spirit of the present disclosure.

### Preparation Example

A sheet-type nonwoven fabric including glass fiber and silica and having a porosity of about 30% was prepared. An adhesive solution was prepared by mixing methyl cyanoacrylate as a water-curable adhesive and an amine catalyst containing a tertiary amine.

The nonwoven fabric was added to the adhesive solution, after which an impregnation process was performed, manufacturing an inner adhesive layer including the nonwoven fabric, the water-curable adhesive with which the nonwoven fabric was impregnated, and the additive. As such, the amount of the water-curable adhesive was measured to be 40 wt % and the amount of the additive was measured to be 10 wt %, based on 100 wt % of the inner adhesive layer.

Thereafter, a pouch for an all-solid-state battery was manufactured by bonding the inner adhesive layer to aluminum as a metal layer.

### Example

A cathode active material slurry was prepared by dispersing 80 parts by weight of LiNi_{0.8}Co_{0.1}Mn_{0.1}O₂ as a cathode active material, 20 parts by weight of Li₆PS₅Cl as a solid electrolyte, 2.5 parts by weight of butadiene rubber as a binder, and 2.5 parts by weight of carbon black as a conductive material in butyl butyrate as an organic solvent. The cathode active material slurry was applied onto an aluminum thin film as a cathode current collector, and then dried, manufacturing a cathode.

An anode active material slurry was prepared by dispersing 60 parts by weight of silicon (Si) and natural graphite as anode active materials, 40 parts by weight of Li₆PS₅Cl as a solid electrolyte, and 2 parts by weight of butadiene rubber as a binder in butyl butyrate as an organic solvent. The anode active material slurry was applied onto a nickel thin film as an anode current collector, and then dried in an oven in an argon atmosphere at 80° C. for 10 minutes and in a vacuum at 100° C. for 2 hours or more, manufacturing an anode.

A Li₆PS₅Cl powder as a sulfide-based solid electrolyte having an argyrodite crystal structure was prepared and then a predetermined pressure was applied thereto, manufacturing a solid electrolyte layer.

Thereafter, a battery assembly including an anode current collector, an anode active material layer, a solid electrolyte layer, a cathode active material layer, and a cathode current collector sequentially stacked was manufactured using the anode, the cathode, and the solid electrolyte layer.

The top and bottom of the battery assembly were covered using the pouch according to Preparation Example 1 and pressed, thus sealing the battery assembly in the pouch except for electrode tabs.

### Comparative Preparation Example

A silicone resin adhesive having insulating properties was prepared as an adhesive to provide adhesion between a pouch and a battery assembly. A pouch for an all-solid-state battery was manufactured by applying the silicone resin adhesive onto aluminum.

### Comparative Example

A pouch-type all-solid-state battery was manufactured in the same manner as in Example, with the exception that the pouch for an all-solid-state battery according to Comparative Preparation Example was used.

### Test Example 1—Heat Exposure Test

A heat exposure test was performed to determine whether internal short circuit occurred when the pouch-type all-solid-state batteries according to Example and Comparative Example were exposed to high temperatures.

Specifically, the pouch-type all-solid-state battery according to Example or Comparative Example was placed in a temperature control chamber, subjected to rated charging in a standard environment (1025 mA/4.35 V, cut-off: 102 mA), and allowed to rest for 10 minutes to less than 72 hours. Thereafter, the chamber was heated at a rate of 5° C./min until the cell temperature reached 130° C., and was maintained at the corresponding temperature for 60 minutes. Subsequently, the chamber was heated at a rate of 5° C./min until the cell temperature reached 150° C., 180° C., 200° C., and 250° C., and was maintained at each temperature for 60 minutes. When the all-solid-state battery ignited in the process of raising the temperature, the test was stopped.

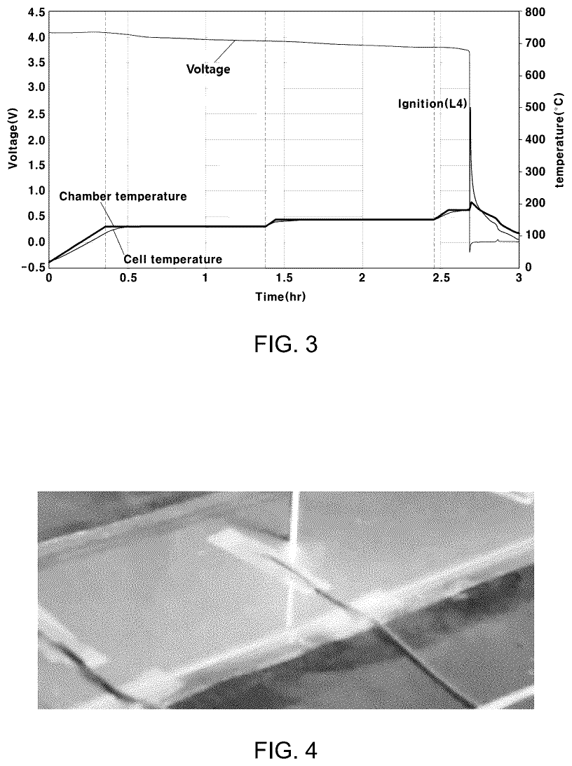

The results of Example are shown in FIG. 2 and the results of Comparative Example are shown in FIG. 3, and judgment was based on the following criteria.

### [L1: Safety, L2: Small Explosion Heat, L3: Leakage, L4: Ignition]

As shown in FIG. 2, in the all-solid-state battery according to Example, ignition was not observed until the temperature of the cell or chamber reached 250° C. In contrast, referring to FIG. 3, in the all-solid-state battery according to Comparative Example, ignition was observed less than 15 minutes after the cell or chamber was exposed to 180° C.

Considering that Example and Comparative Example used the same battery assembly but there was a difference only in the pouch, in Comparative Example, when the pouch according to Comparative Preparation Example was exposed to temperatures of 150° C. or higher, it is deemed that the silicone resin adhesive melted, and thus internal short circuit occurred between the anode current collector and the cathode current collector. In contrast, in Example, when the pouch according to Preparation Example was exposed to high temperatures of 150° C. or more, it is deemed that internal short circuit did not occur because the nonwoven fabric having excellent heat resistance and insulating properties was impregnated with the water-curable adhesive.

### Test Example 2—Penetration Test

In order to measure impact stability of the pouch-type all-solid-state batteries according to Example and Comparative Example, each of the manufactured batteries was fully charged to 100% SoC (state of charge), after which a nail penetration evaluation was performed. As such, the diameter of the nail was fixed at 3.0 mm and the penetration speed of the nail was fixed at 80 mm/min.

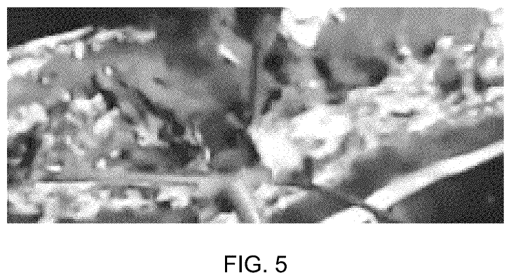

The results of the pouch-type all-solid-state battery according to Example are shown in FIG. 4, and the results of the pouch-type all-solid-state battery according to Comparative Example are shown in FIG. 5.

As shown in FIG. 4, even when the nail penetrated the battery, no ignition phenomenon was observed. In contrast, referring to FIG. 5, an ignition phenomenon occurred in the all-solid-state battery according to Comparative Example.

In Example, as the nail penetrated the pouch and the all-solid-state battery, water and oxygen were introduced into the pouch and the battery assembly, and water reacted with the water-curable adhesive incorporated in the nonwoven fabric, causing a curing phenomenon. As such, the adhesive cured in the nonwoven fabric may serve to enhance insulating properties and may also serve as a type of film that blocks contact between the sulfide-based solid electrolyte and water.

Ultimately, it is deemed that internal short circuit was prevented and generation of hydrogen sulfide (H₂S) gas was suppressed, causing no ignition.

In contrast, in Comparative Example, as the nail penetrated the pouch and the all-solid-state battery, it is deemed that water and oxygen, introduced into the pouch and the battery assembly, reacted with the sulfide-based solid electrolyte, generating hydrogen sulfide gas and causing internal short circuit, resulting in an ignition phenomenon.

According to the present disclosure, a pouch for an all-solid-state battery includes an inner adhesive layer with a nonwoven fabric impregnated with a water-curable adhesive, and thus, when external impact such as penetration of foreign substances occurs and a solid electrolyte is exposed to oxygen and water introduced from the outside, a film is immediately formed on the surface of the electrolyte, thereby suppressing chain reaction due to water and generation of flammable gas.

In addition, since the water-curable adhesive is provided in a state of a nonwoven fabric having high thermal properties being impregnated therewith, it is possible to prevent internal short circuit from occurring even when the adhesive melts due to exposure of the pouch to heat.

The effects of the present disclosure are not limited to the above-mentioned effects. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A pouch for an all-solid-state battery, the pouch comprising:
a metal layer configured to surround a battery assembly; and
an inner adhesive layer configured to provide adhesion between the metal layer and the battery assembly,
wherein the inner adhesive layer comprises a nonwoven fabric impregnated with a water-curable adhesive.

2. The pouch of claim 1, wherein the metal layer comprises aluminum or an aluminum alloy.

3. The pouch of claim 1, wherein the nonwoven fabric comprises any one selected from among glass fiber, silica, and combination thereof.

4. The pouch of claim 1, wherein the nonwoven fabric comprises a coating layer formed on a surface thereof, and the coating layer comprises any one selected from the group consisting of ceramic, silicone, and combination thereof.

5. The pouch of claim 1, wherein the nonwoven fabric has a porosity of about 10% to 70%.

6. The pouch of claim 1, wherein a thickness of the nonwoven fabric is about 10 μm to 300 μm.

7. The pouch of claim 1, wherein the inner adhesive layer comprises about 5 to 70 wt % of the water-curable adhesive.

8. The pouch of claim 1, wherein the water-curable adhesive comprises any one selected from the group consisting of an epoxy resin adhesive, a urethane resin adhesive, a modified silicone resin adhesive, a silicone resin adhesive, a cyanoacrylate resin adhesive, and combinations thereof.

9. The pouch of claim 8, wherein the epoxy resin adhesive comprises diglycidyl ether of bisphenol.

10. The pouch of claim 8, wherein the urethane resin adhesive comprises a soft segment containing polyester diol and a hard segment containing an isocyanate group (—N═C═O).

11. The pouch of claim 8, wherein the cyanoacrylate resin adhesive comprises R-cyanoacrylate, in which R comprises any one selected from the group consisting of hydrogen, linear or branched C₁-C₁₀ alkyl, allyl, and combinations thereof.

12. The pouch of claim 1, wherein the water-curable adhesive further comprises about 25 wt % or less of an additive.

13. The pouch of claim 12, wherein the additive comprises any one selected from the group consisting of an amine catalyst, a liquid catalyst, a particulate metal catalyst, and combinations thereof.

14. The pouch of claim 13, wherein the amine catalyst comprises a tertiary amine.

15. The pouch of claim 13, wherein the liquid catalyst comprises polyester polyol.

16. The pouch of claim 13, wherein the metal catalyst comprises any one selected from the group consisting of tin (Sn), bismuth (Bi), lead (Pb), and combinations thereof.

17. A pouch-type all-solid-state battery comprising:
a battery assembly configured such that an anode current collector, an anode active material layer, a solid electrolyte layer, a cathode active material layer, and a cathode current collector are sequentially stacked; and
the pouch of claim 1 configured to seal the battery assembly.

18. A pouch for an all-solid-state battery, the pouch comprising:
a metal layer configured to surround a battery assembly;
an inner adhesive layer configured to provide adhesion between the metal layer and the battery assembly, the inner adhesive layer comprising a nonwoven fabric impregnated with a water-curable adhesive;
an outer protective resin layer formed on an outer lateral surface of the metal layer, wherein the resin layer comprises a polyester resin.

19. The pouch of claim 18, wherein the polyester resin in the outer protective resin layer is selected from the group consisting of polyethylene terephthalate (PET), polybutylene terephthalate (PBT), and polyethylene naphthalate (PEN).

20. The pouch of claim 18, wherein the metal layer comprises aluminum or an aluminum alloy.
